(19) United States
(12) Patent Application Publication
(10) Pub. No.: US 2025/0337190 A1
(43) Pub. Date: Oct. 30, 2025

(54) STOWABLE ELECTRICAL DEVICE

(71) Applicant: ABB SCHWEIZ AG, Baden (CH)

(72) Inventor: Kevin K. Jolly, Cordova, TN (US)

(21) Appl. No.: 18/644,843

(22) Filed: Apr. 24, 2024

(51) Int. Cl. H01R 13/60; H01R 13/44; H01R 13/52; H01R 13/713; H01R 103/00

(52) U.S. Cl. CPC H01R 13/60; H01R 13/44; H01R 13/5213; H01R 13/7135; H01R 2103/00

(57) ABSTRACT

A plug assembly may include a housing configured to be installed to a first surface of a body. A plug assembly may include a power outlet configured to receive an electrical plug, wherein the power outlet is configured to be removably stored within the housing, wherein in a stored configuration, the power outlet is stored within the housing, wherein in a deployed configuration, the power outlet is exposed from the housing and extends beyond a second surface of the body, wherein the housing is configured to be installed at a location in which the second surface of the body is not modified. A plug assembly may include a plurality of conductors configured to be connected in electrical communication with the power outlet when the power outlet is in the deployed configuration.

### FIELD

This disclosure relates generally to plug assemblies. More particularly, this disclosure relates to plug assemblies configured to be stowable under a surface such as, but not limited to a countertop or other furniture surface.

### BACKGROUND

Horizontal surfaces, such as a kitchen countertop, may not be suitable for an electrical plug outlet. In some such cases, the electrical plug outlet may be disposed on a vertical side surface instead. However, such electrical plug outlets may be inadvertently accessible (e.g., by a child) and can result in accidentally pulling a powered appliance down from the horizontal surface, which can result in physical injuries.

### SUMMARY

In some embodiments, a plug assembly including: a housing configured to be installed to a first surface of a body; a power outlet configured to receive an electrical plug; wherein the power outlet is configured to be removably stored within the housing; wherein in a stored configuration, the power outlet is stored within the housing; wherein in a deployed configuration, the power outlet is exposed from the housing and extends beyond a second surface of the body; wherein the housing is configured to be installed at a location in which the second surface of the body is not modified; and a plurality of conductors configured to be connected in electrical communication with the power outlet when the power outlet is in the deployed configuration.

In some embodiments, a plug assembly, wherein in the stored configuration, the plurality of conductors is configured to be electrically isolated from the power outlet.

In some embodiments, a plug assembly, wherein the power outlet includes a ground fault circuit interrupter.

In some embodiments, a plug assembly, wherein the power outlet includes one or more low voltage accessory inputs configured to receive a low voltage plug.

In some embodiments, a plug assembly, wherein the housing is configured to be sealed to prevent ingress of water.

In some embodiments, a plug assembly, wherein the first surface of the body is an underside of the body.

In some embodiments, a plug assembly, wherein the first surface is a countertop surface.

In some embodiments, a plug assembly, wherein the first surface is a desktop surface, a tabletop surface, or a furniture surface.

In some embodiments, a plug assembly, wherein in the deployed configuration, the power outlet is configured to be disposed above the second surface of the body.

In some embodiments, a plug assembly, wherein in the stored configuration, the power outlet is configured to be disposed below the first surface of the body.

In some embodiments, a plug assembly, wherein the power outlet includes a three-prong opening.

In some embodiments, a plug assembly, wherein the housing is a first housing and the power outlet includes a second housing.

In some embodiments, a plug assembly, wherein the second housing is movable relative to the second housing to transition from the stored configuration to the deployed configuration.

In some embodiments, a plug assembly including: a housing configured to be installed to a surface of a countertop; a power outlet configured to receive an electrical plug; wherein the power outlet is configured to be removably stored within the housing; wherein in a stored configuration, the power outlet is stored within the housing; wherein in a deployed configuration, the power outlet is exposed from the housing and extends beyond the surface of the countertop; wherein the housing is configured to be installed at a location in which a top surface of the countertop is not modified; and a plurality of conductors configured to be connected in electrical communication with the power outlet when the power outlet is in the deployed configuration.

In some embodiments, a plug assembly, wherein in the stored configuration, the plurality of conductors is configured to be electrically isolated from the power outlet.

In some embodiments, a plug assembly, wherein the power outlet includes a ground fault circuit interrupter.

In some embodiments, a plug assembly, wherein the power outlet includes one or more low voltage accessory inputs configured to receive a low voltage plug.

In some embodiments, a plug assembly, wherein the housing is configured to be sealed to prevent ingress of water.

In some embodiments, a plug assembly, wherein the surface of the countertop is an underside of the countertop; and when in the deployed configuration, the power outlet is located above a topside surface of the countertop.

In some embodiments, a plug assembly, wherein the housing is a first housing and the power outlet includes a second housing; wherein the second housing is rotatable relative to the second housing to transition from the stored configuration to the deployed configuration.

### BRIEF DESCRIPTION OF THE DRAWINGS

References are made to the accompanying drawings that form a part of this disclosure and that illustrate embodiments in which the systems and methods described in this Specification can be practiced.

FIG. 1 is a schematic diagram of a body such as, but not limited to, a kitchen cabinet or the like, according to some embodiments.

FIG. 2 is a schematic diagram of the body of FIG. 1, according to some embodiments.

FIG. 3 shows an example of the plug assembly, according to some embodiments.

FIG. 4 shows an example of the plug assembly, according to some embodiments.

FIG. 5 shows a top view of the plug assembly of FIG. 4, according to some embodiments.

Like reference numbers represent the same or similar parts throughout.

### DETAILED DESCRIPTION

Horizontal surfaces, such as a kitchen countertop, may not be suitable for an electrical plug outlet. In some such cases, the electrical plug outlet may be disposed on a vertical side surface instead. However, such electrical plug outlets may be inadvertently accessible (e.g., by a child or inadvertent contact) and can result in accidentally pulling a powered appliance down from the horizontal surface, which can result in physical injuries.

Embodiments of this disclosure are directed to plug assemblies configured to be used with powered equipment disposed on the horizontal surfaces. The plug assemblies herein may be retrievable from below the horizontal surface. In some embodiments, the plug assemblies disclosed herein may be installable without modification of the visible horizontal surface. That is, the plug assembly can be placed into a position in which the plugs are accessible from above the horizontal surface, but without forming a hole in the horizontal surface. In some embodiments, the plug assembly can be referred to as a popup plug assembly. Unlike conventional popup plug assemblies, embodiments of this disclosure may be installed without modification to the horizontal surface. Using the kitchen as an example, this can result in a popup plug usable above the kitchen countertop surface but that does not require modification to the kitchen countertop surface.

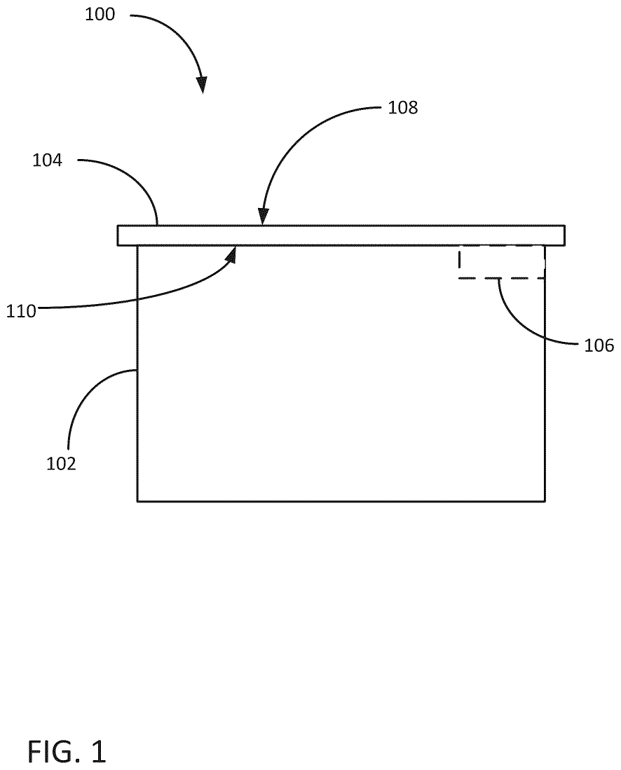

FIG. 1 is a schematic diagram of a body 100 such as, but not limited to, a kitchen cabinet or the like, according to some embodiments. It is to be appreciated that the use of a kitchen cabinet is an example for simplicity of this Specification, but that other types of bodies including a horizontal surface are contemplated within the scope of this disclosure. For example, other types of bodies include furniture items such as desks having a desktop surface; tables having a tabletop surface; other furniture pieces such as, but not limited to, workbenches having a workbench surface; end tables having a tabletop surface; other similar items in which it may be useful to have power access; or the like.

The body 100 includes a housing 102 and a countertop 104. As illustrated in dashed lines, the body 100 also includes a plug assembly 106. In the illustrated embodiment, the plug assembly 106 is in a stored configuration. In the stored configuration, the plug assembly 106 can be disposed under a surface 108 of the countertop 104. In some embodiments, the surface 108 can be referred to as the topside surface of the countertop 104. In some embodiments, the plug assembly 106 can be secured to a surface 110 of the countertop. The surface 110 is opposite the surface 108. In some embodiments, the surface 110 can be referred to as the bottom side surface of the countertop 104. In some embodiments, the surface 108 and the surface 110 can be major surfaces that are planar. In some embodiments, the surface 108 and the surface 110 can be parallel to a surface of the ground on which the housing 102 is located.

In some embodiments, when the plug assembly 106 is in the stored configuration, the plug assembly 106 may be disconnected from a power source. In some embodiments, the power source can be another electrical outlet or an electrical panel for the building in which the body 100 is located.

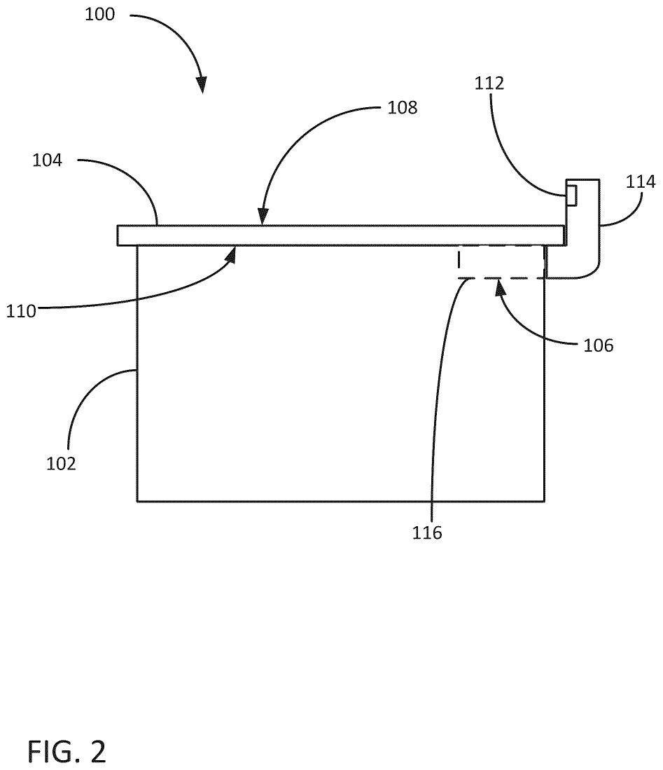

FIG. 2 is a schematic diagram of the body 100, according to some embodiments. Relative to FIG. 1, the illustration in FIG. 2 shows the plug assembly 106 in a deployed configuration. As shown in the deployed configuration, the plug assembly 106 extends so that one or more power outlets 112 are disposed above the surface 108 of the countertop 104. In some embodiments, this positioning may be required by a local code such as a building or electrical code. In some embodiments, the one or more power outlets 112 can be disposed within a housing 114. In some embodiments, the housing 114 is configured to be storable within a housing 116. That is, in some embodiments, the housing 114 is movable relative to the housing 116. As a result, the one or more power outlets 112 can be removably stored within the housing 116. In some embodiments, the housing 116 is configured to be secured to the surface 110 of the countertop 104. In some embodiments, in the deployed configuration the one or more power outlets 112 are exposed from the housing 116. The configuration of plug assembly 106 can, in some embodiments, enable installation of the plug assembly 106 without the surface 108 being modified.

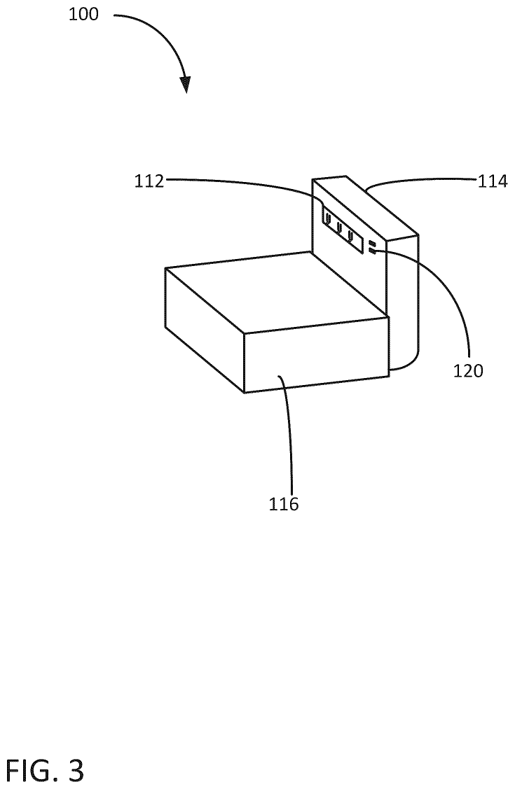

In some embodiments, the one or more power outlets 112 can include a ground fault circuit interrupter (GFCI). In some embodiments, the one or more power outlets 112 include three-prong openings. In some embodiments, the plug assembly 106 can include the one or more power outlets 112 along with one or more accessories. For example, in some embodiments, the plug assembly 106 can include one or more low voltage accessory inputs 120 (FIG. 3) configured to receive a low voltage plug. In some embodiments, a low voltage accessory can include, but is not limited to, a universal serial bus (USB) connection or the like. In some embodiments, the USB connection can include inputs in a variety of USB types, including, but not limited to, USB-A, USB-C, Micro-USB, combinations thereof, or the like). In some embodiments, the low voltage accessory can include a light to provide, for example, lighting in a dark room (e.g., a nightlight). In some embodiments, the low voltage accessory can be one or more types of accent lighting or the like.

FIG. 3 shows an example of the plug assembly 106, according to some embodiments. The plug assembly 106 of FIG. 3 is representative of the plug assembly installed in the body 100 of FIG. 1 and FIG. 2.

In some embodiments, to transition from the stored configuration to the deployed configuration, the housing 114 may be slidable in a first direction and rotated into the deployed configuration. In some embodiments, the first direction can be parallel to the surface 108. In some embodiments, the rotation can be in an amount of 90°. It is to be appreciated that the rotational amount can vary beyond 90°. In some embodiments, the housing 116 can be configured to releasably lock into the deployed configuration. For example, a detent or the like can be used to maintain the housing 116 in the deployed configuration. In some embodiments, the one or more power outlets 112 can be configured to be connected in electrical communication with a power source via one or more conductors. In some embodiments, the one or more conductors can be configured to be electrically connected, providing electrical power to the one or more power outlets 112 when in the deployed configuration but not connected when in the stored configuration or when transitioning into the deployed configuration.

In some embodiments, the plug assembly 106 of FIG. 3 can function similar to a drawer, sliding on one or more rails to translate in the first direction. In some embodiments, the one or more rails can include a pivot member via which the housing 114 can rotate relative to the housing 116 when extended from the housing 116.

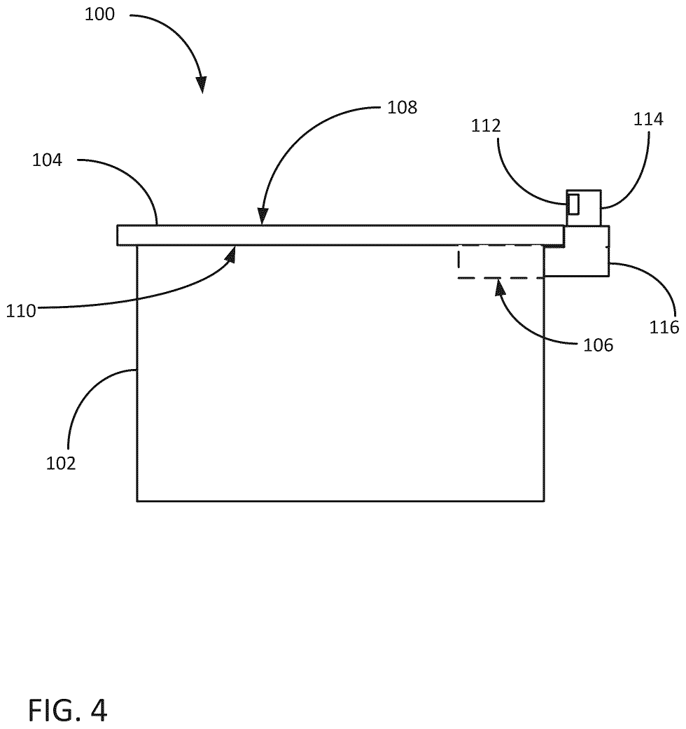

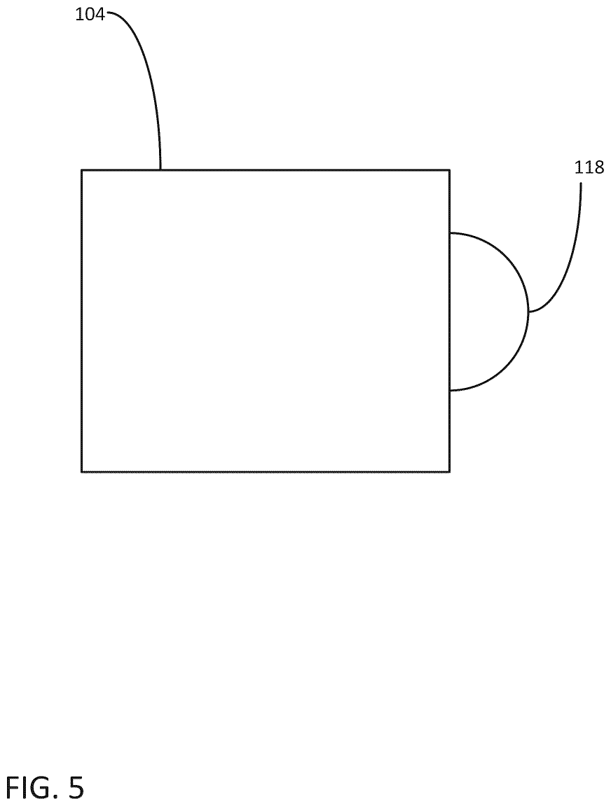

FIG. 4 shows an example of the plug assembly 106, according to some embodiments. FIG. 5 shows a top view of the plug assembly 106 of FIG. 4, according to some embodiments. The plug assembly 106 of FIG. 4 and FIG. 5 is representative of the plug assembly 106 installed in the body 100 of FIG. 1 and FIG. 2.

In the illustrated embodiment, the plug assembly 106 includes the housing 114 and the housing 116. In the illustrated embodiment, the housing 114 is configured to be slidable into and out of the housing 116 to transition from the stored configuration to the deployed configuration. In the illustrated embodiment, the housing 114 is configured to be slidable in a first direction to transition from the stored configuration to the deployed configuration and a second direction to transition from the deployed configuration to the stored configuration, the second direction being opposite to the first direction. In some embodiments, the first direction and the second direction can be perpendicular to the countertop 104. For example, in some embodiments, the first direction and the second direction are vertical, causing the housing 114 to be deployed above the countertop 104 when in the deployed configuration or at or below the countertop 104 when in the stored configuration. In some embodiments, the plug assembly 106 can have a spring-lock feature in which the user pushes in the second direction first to unlock the spring-lock and then moves in the first direction to deploy the plug assembly 106. As noted above regarding FIG. 1, in some embodiments, the one or more power outlets 112 are configured to be electrically isolated from the power source when in the stored configuration and electrically connected to the power source when in the deployed configuration.

In some embodiments, the plug assembly 106 is configured to be sealed to prevent ingress of water into the electrical components.

In some embodiments, the plug assembly 106 can be secured to the surface 110. In some embodiments, the surface 110 is the underside surface of the countertop 104. In some embodiments, the plug assembly 106 can additionally be secured to the housing 102.

As visible in FIG. 5, the plug assembly 106 can include one or more additional members 118. In the illustrated embodiment, the one or more additional members 118 can be a curved piece of material. In some embodiments, the curved piece of material can be semicylindrical in shape. For example, in some embodiments, the one or more additional members 118 can be referred to as a half-round member or the like. In some embodiments, the one or more additional members 118 can be disposed on an outside of the plug assembly 106 to prevent any sharp edges from protruding from the plug assembly 106. In some embodiments, this can, for example, reduce a likelihood that a user can get anything caught on the plug assembly 106 when nearby. For example, this can reduce a likelihood that the user catches an article of clothing, a bag, or other item when passing by the plug assembly 106. This can, for example, increase an overall safety of the plug assembly 106 that is protruding from the body 100.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A plug assembly comprising:
a housing configured to be installed to a first surface of a body;
a power outlet configured to receive an electrical plug;
wherein the power outlet is configured to be removably stored within the housing;
wherein in a stored configuration, the power outlet is stored within the housing;
wherein in a deployed configuration, the power outlet is exposed from the housing and extends beyond a second surface of the body;
wherein the housing is configured to be installed at a location in which the second surface of the body is not modified; and
a plurality of conductors configured to be connected in electrical communication with the power outlet when the power outlet is in the deployed configuration.

2. The plug assembly of claim 1, wherein in the stored configuration, the plurality of conductors is configured to be electrically isolated from the power outlet.

3. The plug assembly of claim 1, wherein the power outlet comprises a ground fault circuit interrupter.

4. The plug assembly of claim 1, wherein the power outlet comprises one or more low voltage accessory inputs configured to receive a low voltage plug.

5. The plug assembly of claim 1, wherein the housing is configured to be sealed to prevent ingress of water.

6. The plug assembly of claim 1, wherein the first surface of the body is an underside of the body.

7. The plug assembly of claim 6, wherein the first surface is a countertop surface.

8. The plug assembly of claim 6, wherein the first surface is a desktop surface, a tabletop surface, or a furniture surface.

9. The plug assembly of claim 6, wherein in the deployed configuration, the power outlet is configured to be disposed above the second surface of the body.

10. The plug assembly of claim 6, wherein in the stored configuration, the power outlet is configured to be disposed below the first surface of the body.

11. The plug assembly of claim 1, wherein the power outlet comprises a three-prong opening.

12. The plug assembly of claim 1, wherein the housing is a first housing and the power outlet comprises a second housing.

13. The plug assembly of claim 12, wherein the second housing is movable relative to the second housing to transition from the stored configuration to the deployed configuration.

14. A plug assembly comprising:
a housing configured to be installed to a surface of a countertop;
a power outlet configured to receive an electrical plug;
wherein the power outlet is configured to be removably stored within the housing;
wherein in a stored configuration, the power outlet is stored within the housing;
wherein in a deployed configuration, the power outlet is exposed from the housing and extends beyond the surface of the countertop;
wherein the housing is configured to be installed at a location in which a top surface of the countertop is not modified; and
a plurality of conductors configured to be connected in electrical communication with the power outlet when the power outlet is in the deployed configuration.

15. The plug assembly of claim 14, wherein in the stored configuration, the plurality of conductors is configured to be electrically isolated from the power outlet.

16. The plug assembly of claim 14, wherein the power outlet comprises a ground fault circuit interrupter.

17. The plug assembly of claim 14, wherein the power outlet comprises one or more low voltage accessory inputs configured to receive a low voltage plug.

18. The plug assembly of claim 14, wherein the housing is configured to be sealed to prevent ingress of water.

19. The plug assembly of claim 14, wherein the surface of the countertop is an underside of the countertop; and when in the deployed configuration, the power outlet is located above a topside surface of the countertop.

20. The plug assembly of claim 14, wherein the housing is a first housing and the power outlet comprises a second housing;
wherein the second housing is rotatable relative to the second housing to transition from the stored configuration to the deployed configuration.
